(19) United States
(12) Patent Application Publication
(10) Pub. No.: US 2006/0144442 A1
(43) Pub. Date: Jul. 6, 2006

(54) Self-locking flow-through joint

(75) Inventor: Michael Lehner, Graenichen (CH)

Correspondence Address: OLIFF & BERRIDGE, PLC, P.O. BOX 19928, ALEXANDRIA, VA, 22320, US

(73) Assignee: KWC AG, Unterkulm (CH)

(21) Appl. No.: 11/320,562

(22) Filed: Dec. 30, 2005

(30) Foreign Application Priority Data
Dec. 30, 2004 (EP) 04030999.9

(51) Int. Cl. F16K 43/00

(52) U.S. Cl. 137/315.01; 285/223

(57) ABSTRACT

The flow-through joint according to the invention comprises an inflow joint part with an inflow opening and an outflow joint part with an outflow opening for diverting a medium from an inflow direction into an outflow direction. In this connection, the outflow joint part is arranged pivotably in relation to the inflow joint part about a common pivoting axis. Their pivoting position in relation to one another is fixed by means of a locking device which adapts a locking force depending on the pressure of the medium in the flow-through joint.

Patent Application No. EP 04030999.9, filed Dec. 30, 2004 in the European Patent Office, is hereby incorporated by reference in its entirety.

The present invention relates to a flow-through joint according to claim 1 and a sanitary fitting with a flow-through joint according to claim 18.

### BACKGROUND

In general, flow-through joints serve for diverting a flowing medium, for example, a liquid or a gas, from an inflow direction to an outflow direction. In this connection, it is advantageously possible to adjust a joint angle formed between the inflow direction and the outflow direction.

Such a flow-through joint is described in DE-C-3616073; the flow-through joint has two joint parts provided with pipe pieces and a hose piece which guides the liquid at least in one joint region. The joint parts are circular cylindrical pipe sockets which are provided with toothings on their end sides. The toothings of the pipe sockets are in engagement with a further toothing of a cover plate, so that undesirable pivoting of the pipe pieces in relation to one another is prevented.

### SUMMARY

In this flow-through joint, the medium is guided in an elastic hose piece, the service life of which is limited inter alia by the material of the hose piece, by the properties of the medium flowing through and also by the number of bending cycles carried out for changing the joint angle.

By virtue of the toothing described, the flow-through joint is equipped with a locking device which is intended to prevent undesirable righting of the joint angle caused by, for example, the pressure, or the flow of a medium, or the gravitational force acting on fitting parts connected mechanically to the flow-through joint. In particular, a sudden increase in pressure or flow in the flow-through joint leads to a torque which tends to align the outflow direction along the inflow direction. This phenomenon can be observed when turning on a water flow through a garden hose, for example.

In existing flow-through joints, this is prevented by a manually releasable lock which, however, either has to be released before desired pivoting or has to be overcome during pivoting.

It is an object of the present invention to provide a flow-through joint with a long service life, irrespective of the medium flowing through and of the number of pivoting operations, ensures reliable locking at any pressure of the medium and in which manual release of a locking mechanism before desired pivoting is not necessary.

This object is achieved by a flow-through joint according to the invention Particularly advantageous embodiments of the flow-through joint are provided with the features specified in the dependent claims.

The flow-through joint according to the invention comprises an inflow joint part with an inflow opening, into which a medium flows from an inflow direction, and an outflow joint part with an outflow opening, through which the medium flows out in a predetermined outflow direction. The outflow joint part is arranged pivotably in relation to the inflow joint part about a common pivoting axis, so that a joint angle between the inflow direction and the outflow direction is adjustable. A locking device, which acts automatically in the flow-through joint and adapts a locking force depending on the pressure of the medium, prevents undesirable independent pivoting of the outflow joint part in relation to the inflow joint part. Additionally, rotation, which is as smooth as possible, is ensured during desired pivoting of the outflow direction in relation to the inflow direction. A hose piece inside the flow-through joint part is not necessary, which in turn increases the service life of the flow-through joint according to the invention.

### BRIEF DESCRIPTION OF THE DRAWINGS

Exemplary embodiments are described in detail below with reference to the drawings, in which numerals, represent like parts, and wherein:

FIG. 1 shows a perspective illustration of a sanitary fitting with a foot element, flow-through joints according to the invention and a water outlet;

FIG. 2a shows a diagrammatic side view of the sanitary fitting shown in FIG. 1 in a basic position of the flow-through joints with an associated control element in the form of a mixing battery for controlling flow-through of a medium;

FIG. 2b shows a diagrammatic side view of the sanitary fitting shown in FIG. 1 and FIG. 2 in a pivoted-out position;

FIG. 3 shows a cutaway perspective illustration of a first embodiment of a flow-through joint in which a pressing-on element is designed like a differential piston;

FIG. 4 shows a longitudinal section through a second embodiment of a flow-through joint with an elastic pressure sleeve;

FIG. 5 shows a cross section along the line V-V of the flow-through joint shown in FIG. 4, and

FIG. 6 shows a longitudinal section through an outflow joint part of the flow-through joint shown in FIG. 4 and FIG. 5 with a cut-in groove delimiting an annular duct and blind holes for connecting the annular duct to an outflow opening.

### DETAILED DESCRIPTION OF EMBODIMENTS

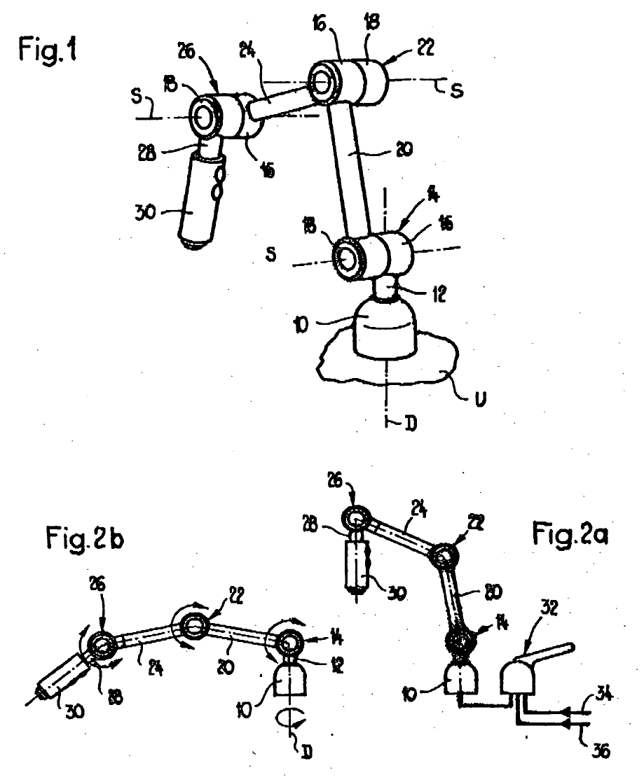

A sanitary fitting according to the invention for the outlet of a medium M, in this case water, which is fastened on a support U by means of a foot element 10, is shown in FIG. 1. Starting from a conical taper of the foot element 10, an inflow pipe 12 connects a pipe system (not shown) to a first flow-through joint 14 mechanically and hydraulically. In this respect, the inflow pipe 12 extends essentially vertically in relation to the support U. The inflow pipe 12 is to this end flow-connected to an inflow joint part 16 of the first flow-through joint 14. A first connecting pipe 20 leads from an outflow joint part 18 of the first flow-through joint 14 assigned to the inflow joint part 16 to the inflow joint part 16 of a second flow-through joint 22.

The outflow joint part 18 and the inflow joint part 16 of the first flow-through joint 14 are pivotable relative to a common pivoting axis S which is oriented essentially parallel to the support U and essentially at right angles to the inflow pipe 12. By pivoting the first connecting pipe 20 relative to the pivoting axis S all parts of the sanitary fitting arranged downstream and connected mechanically to the first connecting pipe 20 are also pivoted in relation to the support U.

In a similar way to the first flow-through joint 14, the outflow joint part 18 is pivotable in relation to the inflow joint part 16 relative to the pivoting axis S in the second flow-through joint 22 as well. A second connecting pipe 24 connects the outflow joint part 18 of the second flow-through joint 22 to the inflow joint part 16 of a third flow-through joint 26 mechanically and in terms of flow. The third flow-through joint 26 preferably has the same construction as the flow-through joints 14 and 22 already mentioned. An outflow pipe 28 leads from the outflow joint part 18 of the third flow-through joint 26 to a water outlet 30 arranged on the free end region of the outflow pipe 28.

The water outlet 30 can be in the form of an open pipe end, a nozzle or a spray head, for example. The water, which is supplied from the pipe system via the inflow pipe 12, the first flow-through joint 14, the first connecting pipe 20, the second flow-through joint 22, the second connecting pipe 24, the third flow-through joint 26 and the outflow pipe 28, is delivered to the surrounding environment, for example into a washbowl, a sink or a container, through the water outlet 30.

Owing to mutually independent pivotability of the individual flow-through joints 14, 22, 26, the position of the outlet element 30 can be changed from a basic position of the sanitary fitting shown in FIG. 2a to a pivoted-out position shown in FIG. 2b. In this connection, it is possible for the size of the free joint angle range for pivoting to be set differently for each flow-through joint 14, 22, 26. In addition, it is possible over the whole free joint angle range to set all joint angles continuously or if appropriate only discrete joint angles. In addition to the pivoting of the sanitary fitting, rotation about an axis of rotation D running centrally through the foot element 10 and the inflow pipe 12 and oriented essentially vertically in relation to the support U is also possible. A corresponding rotation angle range can also be limited and comprise continuously or discretely distributed angle positions.

In order to prevent undesirable pivoting or righting of the sanitary fitting which is independent or brought about by the pressure in the medium M, the flow-through joints 14, 22, 26 are equipped with locking devices. The locking devices generate a locking force which counteracts pivoting. In this connection, a minimum locking force in the pressure-free state in relation to the surrounding environment can be preset individually and adapted to a respective mechanical supporting function of the individual flow-through joints 14, 22, 26.

By virtue of the independent pivoting and rotation of the sanitary fitting, the water outlet 30 can reach at least virtually any position within an imaginary circle centered around the foot element 10 with a radius which corresponds essentially to the extended sanitary fitting. By limiting the joint angle range of the flow-through joints 14, 22, 26 or the rotation angle range about the axis of rotation D, positioning can be limited.

The elements in contact with the medium M, such as the flow-through joints 14, 22, 26, the pipes 12, 20, 24, 28 and the water outlet 30, are preferably made from a corrosion-inert metal or an appropriate alloy or coated with these, so that the sanitary fitting according to the invention is suitable in particular for discharging drinking water.

A control element 32, assigned to the sanitary fitting, in the form of a mixing battery 32, which controls the flow-through of the water from the pipe system, in particular from a hot water supply line 34 and a cold water supply line 36, is shown in FIG. 2a. Alternatively, the mixing battery can also be integrated into the foot element 10 or replaced by another control element 32, for example a stopcock.

The construction and the functioning of two particularly preferred embodiments of the flow-through joints 14, 22, 26 according to the invention, such as is used in a sanitary fitting shown in FIG. 1 and FIGS. 2a/2b, are described in detail below.

### DETAILED DESCRIPTION OF EMBODIMENTS

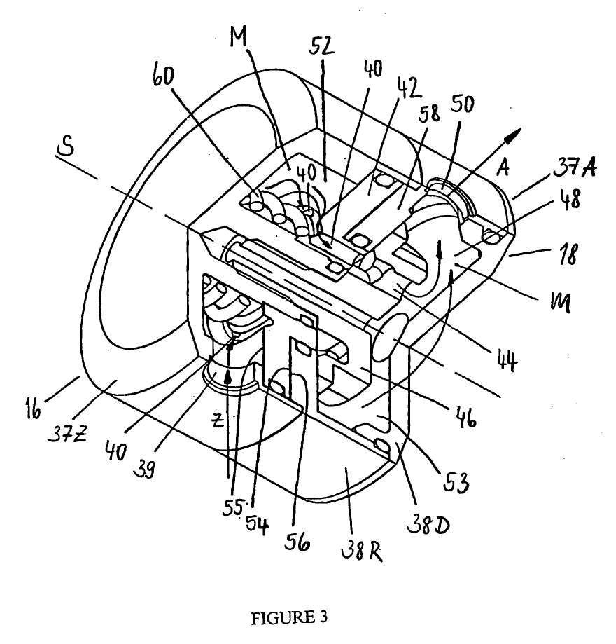

A first embodiment of the flow-through joint 14, 22, 26 according to the invention is shown in FIG. 3. This embodiment of the flow-through joint 14, 22, 26 comprises a cup-like inflow housing 37Z assigned to the inflow joint part 16 and a likewise cup-shaped outflow housing 37A assigned to the outflow joint part 18, both, the inflow housing 37Z and the outflow housing 37A, being arranged coaxially relative to the pivoting axis S and with their cup openings facing one another. While the inflow housing 37Z is made in one piece, the outflow housing 37A is formed by a cup ring 38R and an end-side joint cover 38D.

An inflow opening 39, through which the medium M flows into the inflow joint part 16 along an inflow direction Z, is formed in the inflow housing 37Z. The medium M flows into an inner space 48, delimited by the inflow housing 37A, of the outflow joint part 18 via flow-through ducts 40 in a pressing-on element 42 assigned to the inflow joint part 16 and cutouts 44 of a connecting screw 46 connecting the inflow joint part 16 and the outflow joint part 18. The medium M then leaves in an outflow direction A through an outflow opening 50 formed in the outflow housing 37A. This embodiment, like the second embodiment described below as well, requires no elastic hose pieces and therefore has a markedly longer service life in comparison with flow-through joints with hose pieces. Corresponding arrows are drawn in FIG. 3 to illustrate the flow-through of the medium M.

The flow-through ducts 40 and cutouts 44 extend essentially parallel to the pivoting axis S and at right angles to the inflow direction Z and outflow direction A. Accordingly, the medium M is at least in sections guided parallel to the pivoting axis S and to the inflow direction Z and outflow direction A. In this way, a righting characteristic of a torque acting counter to the locking force, which characteristic is caused as in the example mentioned previously of a garden hose and appears when a pressure increase occurs in the flow-through joint, is avoided or suppressed by means of the flow.

The inflow joint part 16 and the outflow joint part 18 are fastened to one another non-displaceably axially along the pivoting axis S by means of the connecting screw 46. An essentially annular inflow duct 52 is formed in the inflow housing 37Z, and an outflow space 53 is formed in the inner space 48 of the outflow housing 37A. The inflow duct 52 is delimited on the outflow side by the pressing-on element 42.

The pressing-on element 42 is designed like a differential piston in form and function and is mounted displaceably relative to the inflow joint part 16 and the outflow joint part 18 to a small extent of for instance 0.1 mm to 0.5 mm in the direction of the pivoting axis S. An annular, hydraulically active surface 55 of the pressing-on element 42 delimiting the inflow duct 52 on the inflow side is in this connection dimensioned to be larger than its hydraulically active surface in contact with the medium M on the outflow joint part side. A surface which is in contact with the medium M or located in the medium M and influences a mechanical positioning force, here the locking force, is designated a hydraulically active surface 55.

In the embodiment shown in FIG. 3, the hydraulically active surface 55 extends at least virtually at right angles to the pivoting axis S. Owing to the size of the hydraulically active surface 55 and its orientation, a resultant force, acting in the direction of the outflow joint part 18, on the pressing-on element 42 or a corresponding pressing-on force on parts in mechanical contact with the pressing-on element 42 is produced at a given pressure in the inflow duct 52.

Additionally, the pressing-on element 42 is acted on by means of a spring force generated by a helical spring 60 supported in the inflow housing 37Z and is thus prestressed in the direction of the outflow joint part 18. On the outflow side, the pressing-on element 42 comprises a pressing-on surface 54 which lies opposite the inflow-side hydraulically active surface and interacts with a pressing surface 56 of a pressing element 58 formed on the cup ring 38R of the outflow joint part 18. Depending on the pressure of the medium M in the flow-through joint 14, 22, 26, the pressing-on surface 54 is pressed to a varying degree against the pressing surface 56, and a friction of the two surfaces 54, 56 lying on one another which appears when the outflow joint part 18 is pivoted in relation to the inflow joint part 16 is accordingly adapted.

The locking force brought about by the friction between the pressing-on surface 54 of the pressing-on element 42 and the pressing surface 56 of the pressing element 58 is consequently increased when the pressure in the medium is raised in relation to the ambient pressure and in this way makes relative pivoting of the outflow joint part 18 in relation to the inflow joint part 16 more difficult. The locking force is in this connection adapted to the pressure in the medium M automatically and without external control or energy supply.

A minimum pressing-on pressure between the pressing-on surface 54 and the pressing surface 56, or a minimum locking force, can be preset by way of a tightening torque of the connecting screw 46. The minimum pressing-on pressure determines the smoothness of pivoting for the case when the pressure in the flow-through joint 14, 22, 26 is the same as the ambient pressure, for example if no medium M flows through the flow-through joint 14, 22, 26. As already mentioned in the description of the sanitary fitting, the mechanical supporting function of the flow-through joint 14, 22, 26 relative to connected fitting parts, such as the pipes 20, 24, 28 shown in FIG. 1 to FIG. 3, the flow-through joints 22, 26 arranged downstream and the water outlet 30, is also to be taken into consideration for the setting of the minimum locking force. Accordingly, the size of the tightening torques for the connecting screws 46 can be preset differently for each individual flow-through joint 14, 22, 26.

The pressing-on element 42, the pressing element 58 and the joint cover 38D attached on the outflow joint part side are sealed against leakage of the medium M to the surrounding environment by means of O-rings 64.

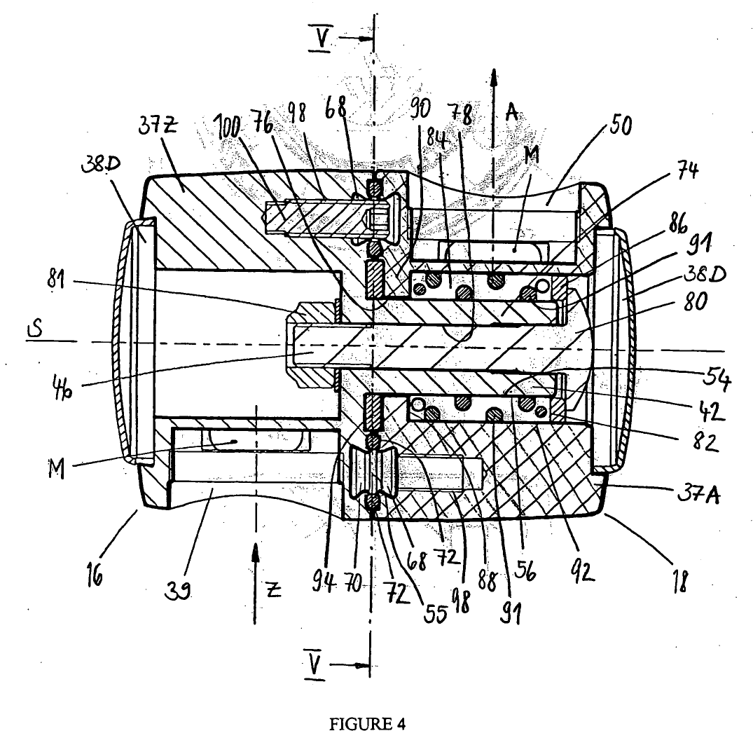

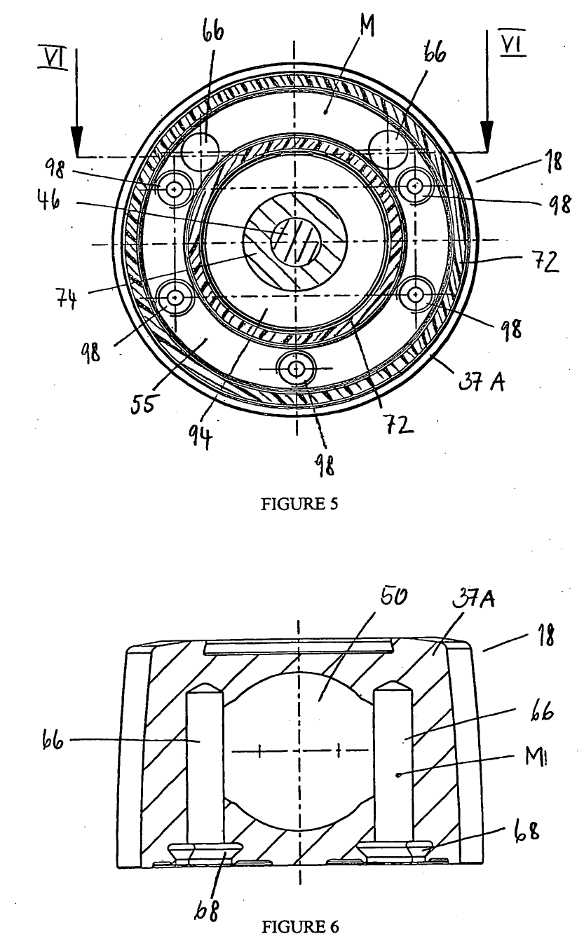

A second particularly preferred embodiment of a flow-through joint 14, 22, 26 according to the invention is described below. As shown by the longitudinal section in FIG. 4 and the cross section in FIG. 5, the flow-through joint 14, 22, 26 has an essentially cylindrical outer shape, both the inflow housing 37Z and the outflow housing 37A being closed on the end side by joint covers 38D. In this embodiment, the joint covers 38D do not close spaces in contact with the medium M but serve rather for covering the access to the connecting screw 46.

As in the first embodiment, the inflow joint part 16 and the outflow joint part 18 are again arranged coaxially relative to the pivoting axis S and interconnected via the connecting screw 46. In contrast to the first embodiment, however, the inflow joint part 16 and the outflow joint part 18 are here designed axially displaceable in relation to one another in a very small range of, for instance, 0.1 mm to 0.3 mm.

The medium M flows via the inflow opening 39 formed in the inflow housing 37Z and blind holes 66 flow-connected to said opening, which are similar to the blind holes 66 of the outflow joint part 18 described in detail in connection with FIG. 5 and FIG. 6, into an annular duct 70 running around radially and formed by undercut grooves 68. To this end, the grooves 68 lie opposite one another on the opening side and are formed on facing lateral surfaces of on the one hand the inflow joint part 16 and on the other hand an inner bearing ring 90 assigned to the outflow joint part 18. The inner bearing ring 90 is formed in one piece on the outflow housing 37A, but can alternatively also be mounted displaceably in a piston-like manner in the direction of the pivoting axis S in the outflow housing 37A. In the latter case, the inflow joint part 16 and the outflow joint part 18 are then interconnected non-displaceably.

The medium M leaves the flow-through joint 14, 22, 26 via the blind holes 66 of the outflow joint part 18, which are open on the one hand to the annular duct 70 and on the other hand to the outflow opening 50. The annular duct 70 is sealed radially on the inside and radially on the outside by further O-rings 72. In this embodiment, the hydraulically active surface 55 is formed by an annular surface located in the annular duct 70 between the radially outer and the radially inner O-ring 72 and likewise extends essentially at right angles to the pivoting axis S.

A cylindrical, annular extension 74 designed on the inflow housing 37Z of the inflow joint part 16 extends through a central cylindrical opening 76 in the inner bearing ring 90 of the outflow joint part 18 into the outflow joint part 18. In this connection, the annular extension 74 forms the pressing-on element 42 with the cylindrical pressing-on surface 54 running around radially on the outside.

The connecting screw 46 is mounted in a central leadthrough 78 of the annular extension 74. On the inflow side, the connecting screw 46 is supported in the inflow housing 37Z by means of a nut 81 and a washer. On the outflow side, a pressure disk 86 is clamped between the head 80 of the screw and an end surface 82 of a pressure sleeve 84 which is arranged concentrically relative to the annular extension 74 and surrounds the pressing-on surface 54 of the annular extension 74 cylindrically.

An opposite inflow-side end surface 88 of the pressure sleeve 84 bears against the inner bearing ring 90. The pressure sleeve 84 is consequently supported at one end on the inflow joint part 16 and at the other end on the inner bearing ring 90 assigned to the outflow joint part 18. The axial extent of the pressure sleeve 84 is fixed by the distance between the inner bearing ring 90 and the pressure disk 86.

The pressure sleeve 84 is made from an elastic material of at least virtually constant volume, preferably a plastic, such as POM for instance, in particular, polyacetals such as Hostaform® C 9021. It has the form of a hollow cylinder and consists of two half-shells. Friction rings 91 are inserted radially on the inside and radially on the outside in circumferential U-shaped grooves of the pressure sleeve 84 in such a way that they protrude radially at least partly from the pressure sleeve 84. By virtue of this, the friction rings 91 arranged radially on the inside bear against the pressing-on surface 54 and the friction rings arranged radially on the outside bear against the cylindrical pressing surface 56 of an inner wall 92 of the outflow joint part 18, which is formed as a pressing element 58 and concentrically with the pressing-on surface 54 relative to the pivoting axis S.

If the axial extent of the pressure sleeve 84 is then reduced, this inevitably leads to radial expansion or arching of the pressure sleeve 84. The pressing-on pressure brought about radially between the pressing-on surface 54 and the pressing surface 56 by the friction rings 91 or alternatively also by the pressure sleeve 84 itself is thus increased. The increased pressing-on pressure leads in turn to greater friction between the pressing-on surface 54 and the pressing surface 56 and thus to increased locking force counter to the relative pivoting of the outflow joint part 18 in relation to the inflow joint part 16.

The axial extent of the pressure sleeve 84 and consequently the pressing-on pressure is determined on the one hand by the tightening torque of the connecting screw 46 and on the other hand by the pressure of the medium M in the annular duct 70 in relation to the ambient pressure, that is by the resultant force acting on the hydraulically active surface 55. If either the tightening torque of the connecting screw 46 or the pressure of the medium M in the annular duct 70 is increased, that is in the former case the inflow joint part 16 is pressed slightly toward the outflow joint part 18 and in the latter case the inflow joint part 16 is pressed slightly away from the outflow joint part 18, the axial extent of the pressure sleeve is reduced and as a result the pressing-on pressure between the pressing-on surface 54 and the pressing surface 56 increases. In the latter case, this leads pressure-dependently to an automatically and continuously increased locking force between the outflow joint part 18 and the inflow joint part 16.

As described in connection with the first embodiment, the former case of the adjustment of the tightening torque brings about an adjustment of the minimum locking force in order in particular to counteract mechanical bearing loading by connected fitting parts.

For especially smooth pivoting in the pressure-free state of the flow-through joint 14, 22, 26 in relation to the ambient pressure, a sliding disk 94 is arranged on the annular extension 74 between facing lateral surfaces of the inflow joint part 16 and of the inner bearing ring 90.

FIG. 5 shows a cross section along a plane designated by V through the flow-through joint 14, 22, 26 shown in FIG. 4. This plane runs in particular through the annular duct 70, the sliding disk 94 and the annular extension 74. By virtue of this, annular-duct-side inlet openings of the blind holes 66 and also threaded bores 98 likewise open toward the annular duct 70 can be seen. As shown in FIG. 4, threaded pins 100 can be screwed into these threaded bores 98. In interaction with corresponding threaded pins 100, which can be arranged in the opposite groove 68, the joint angle range in which the outflow joint part 18 is pivotable in relation to the inflow joint part 16 is limited.

FIG. 6 shows a section through the plane designated by VI in FIG. 5 through the outflow joint part 18 without the joint cover 38D. The cut-in annular duct 70, the inlet openings 96 of the blind holes 66 and the outflow opening 50 are clearly visible. A connection between the blind holes 66 and the outflow opening 50 is machined out during the manufacturing process, after drilling of the blind holes 66 and the outflow opening 50, by relief-milling by means of a milling disk introduced through the outflow opening 50.

Like the sanitary fitting, the elements of the flow-through joint according to the invention which are in contact with the medium M, such as the inflow housing 37Z and the outflow housing 37A, are preferably made from a corrosion-inert metal or an appropriate alloy or coated with these. This makes it possible in particular to use them for conducting drinking water.

What is claimed is:

1. A flow-through joint for diverting a medium, which flows into an inflow joint part through an inflow opening in an inflow direction and flows out in an outflow direction predetermined by an outflow opening of an outflow joint part, the outflow joint part and the inflow joint part being arranged pivotably relative to one another about a common pivoting axis and being fixable in their relative pivoting position in relation to one another by means of a locking device providing a locking force, wherein the locking device is an automatically acting locking device which adapts the locking force depending on the pressure of the medium in the flow-through joint.

2. The flow-through joint as claimed in claim 1, wherein the locking device comprises at least one hydraulically active surface which is exposed to the medium and codetermines the magnitude of the locking force.

3. The flow-through joint as claimed in claim 2, wherein the locking device comprises a pressing-on element with a pressing-on surface, which pressing-on element is assigned to the inflow joint part and comprises the hydraulically active surface, and a pressing element with a pressing surface which can interact with the pressing-on surface, which pressing element is assigned to the outflow joint part, an increased pressure in the medium leading to a greater locking force.

4. The flow-through joint as claimed in claim 3, wherein the pressing-on element is designed like a differential piston and its pressing-on surface is of disk-shaped design on the outflow side, and the pressing-on element is mounted displaceably relative to the inflow joint part and the outflow joint part in the direction of the pivoting axis and comprises a hydraulically active surface in each case on the inflow side and on the outflow side, the inflow-side hydraulically active surface being formed by a surface of the pressing-on element lying opposite the pressing-on surface, the pressing-on surface being oriented essentially at right angles to the pivoting axis, and the pressing-on surface and the pressing surface preferably abut directly against one another.

5. The flow-through joint as claimed in claim 4, wherein the inflow joint part comprises a cup-like inflow housing and the outflow joint part comprises a likewise cup-shaped outflow housing, the inflow housing and the outflow housing being arranged coaxially relative to the pivoting axis, the inflow joint part and the outflow joint part being interconnected non-displaceably axially preferably by a screwed connection, and an annular inflow duct connected to the inflow opening being formed in the inflow joint part and an outflow space being formed in the outflow joint part.

6. The flow-through joint as claimed in claim 5, wherein the pressing-on element delimits with the inflow-side hydraulically active surface the inflow duct inside the inflow joint part and comprises a flow-through duct for conducting the medium through from the inflow duct to the outflow space, and the pressing-on element is pressed by the inflow joint part against the pressing surface of the outflow joint part by means of a prestressed helical spring.

7. The flow-through joint as claimed in claim 5, wherein the pressing element is formed on the outflow housing and delimits the outflow space.

8. The flow-through joint as claimed in claim 2, wherein the pressing-on surface and the pressing surface are essentially of cylindrical design and arranged concentrically relative to the pivoting axis, a pressing-on pressure bringing about the locking force being provided by compression, which takes place parallel to the direction of the pivoting axis and is dependent on the pressure of the medium in the flow-through joint, of an elastic pressure sleeve of essentially constant volume which is arranged radially between the pressing-on surface and the pressing surface.

9. The flow-through joint as claimed in claim 8, wherein the pressure sleeve is supported at one end on the inflow joint part and at the other end on the inner bearing ring assigned to the outflow joint part.

10. The flow-through joint as claimed in claim 8, wherein an annular duct running around radially is formed between the inflow joint part and the inner bearing ring, which annular duct is formed in each case on one side by grooves running around in the inflow joint part and opposite in the inner beading ring and also sealing 0-rings arranged radially on the inside and radially on the outside relative to the grooves, an annular surface between the 0-rings forming the hydraulically active surface.

11. The flow-through joint as claimed in claim 3, wherein the pressure sleeve is made from a plastic, preferably a polyacetal.

12. The flow-through joint as claimed in claim 8, wherein friction rings are inserted radially on the inside and radially on the outside in circumferential U-shaped grooves of the pressure sleeve in such a way that the friction rings protrude radially at least partly from the pressure sleeve and, by virtue of this, the friction rings arranged radially on the inside bear or rub against the pressing-on surface and the friction rings arranged radially on the outside bear or rub against the pressing surface.

13. The flow-through joint as claimed in claim 8, wherein the pressure sleeve is of cylindrical design and consists of two half-shells.

14. The flow-through joint as claimed in claim 8, wherein a sliding disk is arranged between the inflow joint part and the inner bearing ring.

15. The flow-through joint as claimed in claim 9, wherein the inner bearing ring is held firmly relative to the outflow housing.

16. The flow-through joint as claimed in claim 2, wherein a joint angle range in which the outflow joint part is pivotable about the pivoting axis in relation to the inflow joint part is limited by means of limiting stops, preferably by means of threaded pins arranged on the inflow joint part and/or on the outflow joint part.

17. The flow-through joint as claimed in claims 2, wherein the medium in the flow-through joint is at least in sections guided parallel to the pivoting axis and at least virtually at right angles to the inflow direction and to the outflow direction, and the hydraulically active surface is oriented at right angles to the pivoting axis.

18. A sanitary fitting with a flow-through joint as claimed in claim 1, which comprises a connection to a pipe system by means of an inflow pipe, which is connected to an inflow joint part of the flow-through joint, and a water outlet, which is connected in terms of flow and/or mechanically to an outflow joint part of the flow-through joint via an outflow pipe.

19. The sanitary fitting as claimed in claim 18, which comprises at least two flow-through joints, in each case an outflow joint part of a flow-through joint arranged upstream being, via a connecting pipe, connected in terms of flow and/or mechanically to an inflow joint part of a further flow-through joint arranged downstream.

20. The sanitary fitting as claimed in claim 18, which comprises a control element assigned for flow purposes, preferably in the form of a stopcock or a mixing battery, which influences the flow-through of the medium through the sanitary fitting.

21. The sanitary fitting as claimed in claim 19, wherein the flow-through joints are in each case provided with a locking force of different size, in the pressure-free state in relation to the surrounding environment as well, in order in particular to support fitting parts connected mechanically to them.
